(19) United States
(12) Patent Application Publication
(10) Pub. No.: US 2004/0264480 A1
(43) Pub. Date: Dec. 30, 2004

(54) Functional distribution for network control units

(76) Inventors: Peter Leis, Penzberg (DE); Rainer Liebhart, Schrobenhausen (DE)

Correspondence Address: Siemens Corporation, Intellectual Property Department, 170 Wood Avenue South, Iselin, NJ, 08830, US

(21) Appl. No.: 10/493,543

(22) PCT Filed: Oct. 22, 2002
(86) PCT No.: PCT/DE02/03981

(30) Foreign Application Priority Data
Oct. 22, 2001 (DE) 101 52 015.8

(51) Int. Cl. H04L 12/28; H04L 12/56

(52) U.S. Cl. 370/401

(57) ABSTRACT

The functions associated with a control function are distributed on at least two units, a peripheral element and a communication management element. At least the access control function is assigned to the peripheral element and at least the communication management control is assigned to the communication management element. Additionally, the peripheral element comprises preferably a signalling proxy server for transmitting messages of the communication management element.

### CROSS REFERENCE TO RELATED APPLICATIONS

This application is the U.S. National Stage of International Application No. PCT/DE02/03981, filed Oct. 22, 2002 and claims the benefit thereof. The International Application claims the benefits of German application No. 10152015.8 filed Oct. 22, 2001, both of the applications are incorporated by reference herein in their entirety.

### FIELD OF INVENTION

The invention relates to functional distribution for network control units.

### BACKGROUND OF INVENTION

The ITU-T standard H.323 defines a protocol family for standardized control of services in multimedia packet networks (in particular IP networks), i.e. of networks in which a plurality of different services can be transferred. These services are implemented in a standardized multimedia environment and are also called ‘multimedia applications’. In this case, the concept of multimedia applications includes both services such as conventional telephony (keyword ‘Voice over IP (VoIP)’) and services such as fax, telephone conference, video conference, Video on Demand (VoD) and other similar services.

The essential network components of the packet-based H.323 standard are end points (EP units requiring to use applications, e.g. a PC client), gateways (GW) for the transition into the line-based telephone network, Multipoint Control Units (MCU) for controlling conferences, and gatekeepers (GK).

In this case, a gatekeeper controls the access into the IP network for all H.323 network components (end points, GW, MCU) which belong to its zone. A GK is assigned the following functions:

1) Admission control (network access control)

2) Call authorization (authentication of connections)

3) Address translation/resolution (conversion of the selection information in IP addresses)

4) Call control signaling (control of the connection setup and connection cleardown, and of the subscriber features)

5) GK communication (communication with the GKs of other zones).

The cited functions are based (directly of indirectly) on the processing of H.225 Call Signaling and RAS (registration, admission, status) messages. They are implemented in the architecture of the H.323 standard in a monolithic gatekeeper function. In this case, the gatekeeper schedules both RAS and H.225 Call Signaling and derives therefrom at least the corresponding actions which are required in the context of the Authentication, Authorization, Address Resolution, Call and Connection Control functions.

Consequently, a Border Element which is conditioned by the monolithic structure of the gatekeeper must always be constructed at the transition between two networks (e.g. the intranet of a network operator with a gatekeeper and the internet), the complete gatekeeper functionality being implemented in said Border Element. Scaling is only possible overall, but not in relation to specific functions, thereby hindering scalability and redundancy. This is economically disadvantageous.

At present, no known mechanisms exist which can solve the above problem. The relevant H.323 standard is not concerned with the issue of scalability of network components such as the gatekeeper. Consequently, no solutions are suggested by the H.323 standard.

### SUMMARY OF INVENTION

The aim of the invention is to demonstrate a way of improving the scalability of a monolithically structured gatekeeper.

The problem described at the beginning arises because one unit executes two tasks which are actually different: network access (Access Control) and network signaling (Call Processing and Call Control). Scalability and redundancy are hindered for a gatekeeper because this functional distribution is missing.

It is economically advantageous to separate off the complex Call and Connection Control parts of the gatekeeper from the actual Border Element. Having reduced functions and being simplified in this way, the Border Element then regulates and controls only the access to the network of the service provider. The Border Element is also called ‘Access Control Element’ below.

The comparatively complex Call Control functions are located in a Call Processing unit, or in a few Call Processing units, which is also called ‘Call Control Element’ below.

As a result of the claimed decomposition of the H.323 gatekeeper into a (simplified) Border Element and a Call Control Element, the problems cited at the beginning are easily solved.

It is advantageous to arrange a Call Control Element centrally. If a provider offers transitions to various networks, it is advantageous that only one Access Control Element need be installed per transition, while the use of an additional Call Control Element is often unnecessary due to the proposed centralization.

An H.323 gatekeeper is divided into two independent network elements. On the basis of the different tasks of a gatekeeper, the previous gatekeeper described in the H.323 standard is replaced by one or more simplified Border Elements and one or more Call Control Elements. The claimed function split is illustrated in FIG. 1; a claimed arrangement of the elements in the network is illustrated in FIG. 2.

The proposed simplified Border Element has the task of allowing the transition between the network of the end point and that of the service provider. The Border Element is first reduced to the main function ‘Access Control’. The ‘Signaling Proxy’ function can also be added.

The Access Control function is based on the processing of the RAS messages of the H.323 standard, said messages being sent by the end point in order to indicate a registration or connection request. The Border Element schedules the RM messages and carries out the authorization of the end point, in the simplest case by checking a user-id and a password.

The Signaling Proxy function comprises the correct forwarding of incoming H.225 Call Signaling and H.245 Connection Control messages. Since the Border Element does not perform any conventional Call Processing tasks, all H.225 and H.245 messages are forwarded transparently to the Call Control Element. This takes place for both originating traffic from an end point and for terminating traffic to an end point. As a result of this function, the end points advantageously require no knowledge of the structure of the provider network. The Signaling Proxy function of the Border Element therefore assumes NAT (Network Address Translation) functionality for the H.225/H.245 messages. This substantive matter is illustrated in FIG. 3.

It is also possible to implement security functions in the Border Element. Consequently, the Border Element can also guarantee both the authenticity of the end point and the integrity of the messages at H.323 level (firewall functionality). The security mechanisms can be applied to both H.225 and to H.245 messages.

The proposed newly defined Call Control Element schedules and processes the connection-related H.225 and H.245 signaling. As a result of the described separation of the gatekeeper, the Call Control Element requires no knowledge of the RAS signaling. On the basis of the H.225 and H.245 messages, the Call Control Element is responsible for the Call Processing tasks which are also known from the TDM (Time Division Multiplex). Examples of these tasks are:

routing,

billing,

supplementary features,

conversion to other signaling (e.g. SIP, SILT, BICC:ISUP).

The invention describes a way of splitting the monolithic gatekeeper architecture described in the H.323 standard. The splitting is based on the different tasks of the gatekeeper. Using the described way, the different tasks can also be performed by different network elements Access Control Element and Call Control Element). As a result of the described functional separation of the gatekeeper, a physical separation also becomes possible, in which the various gatekeeper functions are implemented on various computers in the network. As a result of this physical separation into N Border Elements and M Call Control Elements (typically N>M), the number of Border Elements and Call Control Elements can then be increased or reduced independently from each other, thereby providing improved scalability and redundancy.

### BRIEF DESCRIPTION OF THE DRAWINGS

Further exemplary embodiments of the invention are illustrated in the drawings, in which:

FIG. 1 shows an arrangement of the invention having an end point EP and an assigned gatekeeper GK which is broken down according to the invention into a Call Control Element CE comprising the Call Control CC function and a Border Element BE comprising the Access Control AC and Signaling Proxy SP functions;

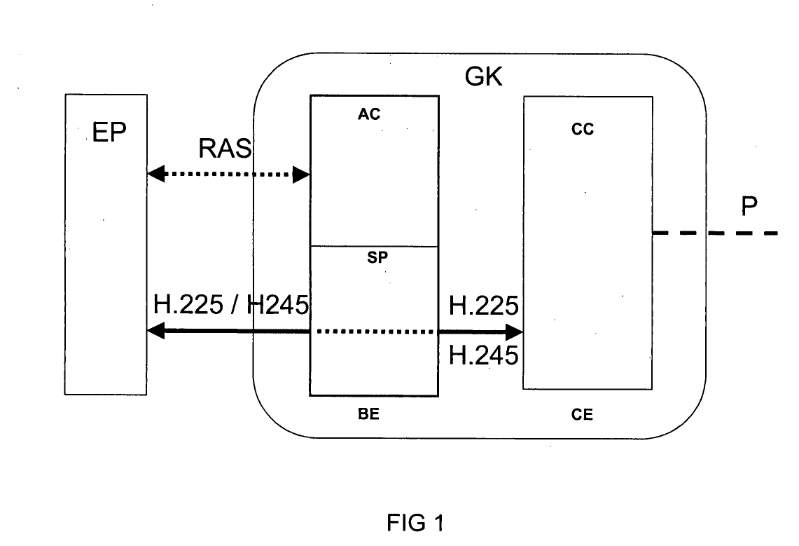

FIG. 2 shows a group of three networks KN in which are arranged two Border Elements BE, as claimed in the invention, for connecting the networks KN₁, KN₂ to the network KN₃, and one central Call Control Element CE;

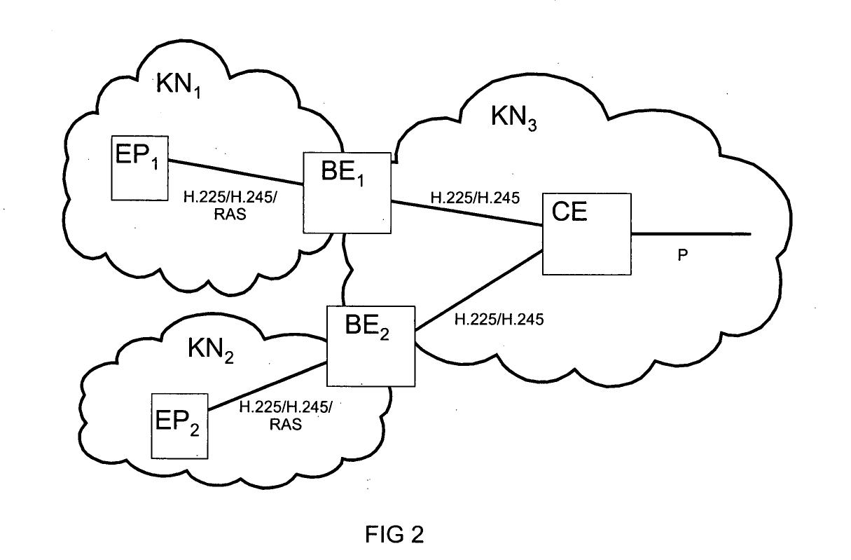

FIG. 3 shows an arrangement of the invention, in order to illustrate the way in which the Signaling Proxy SP function works, said function being included in a claimed Border Element BE.

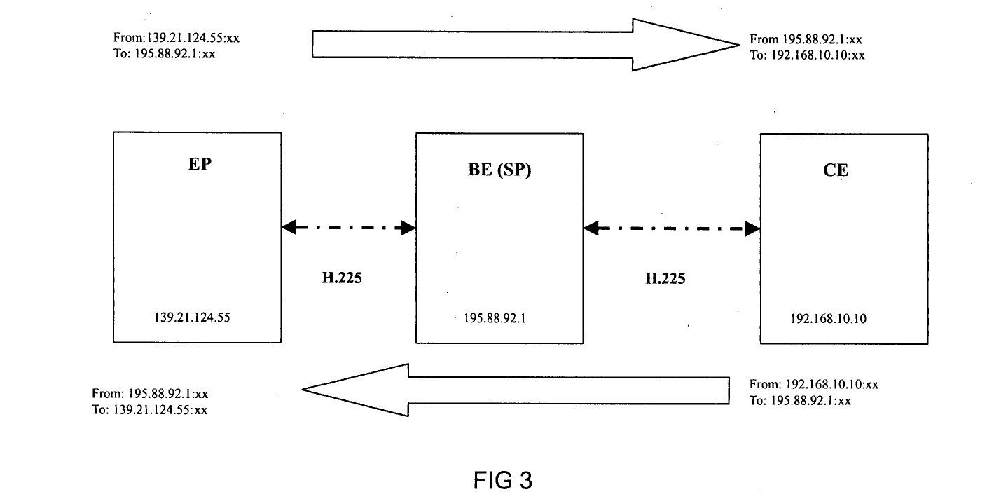

### DETAILED DESCRIPTION OF INVENTION

For the purpose of an exemplary embodiment, an H.323 end point EP in the public internet sets up a telephone connection via a gatekeeper GK. In accordance with the invention, the gatekeeper functionality is divided into a Border Element BE comprising the Access Control AE function and optionally the Signaling Proxy SP function, and a Call Control Element CE comprising the Call Control CC function.

The end point EP first registers itself, by means of an RRQ (Registration Request) message, with the gatekeeper address which is known to it for the purpose of RAS. This is the public IP address of the Border Element BE. The Border Element BE checks the authorization of the subscriber (possibly by referring to an external central database) and confirms the registration by means of an RCF (Registration Confirm) message.

If the end point EP wishes to set up a connection, it sends an ARQ (Admission Request) message to the Border Element BE. The Access Control tasks of the Border Element BE are completed when it sends the confirmation message ACF (Admission Confirm).

All subsequent H.225 and H.245 messages (e.g. H.225 Setup, Alert or Connect) are now forwarded to the IP address of the Call Control Element CE, which address is known only to the Border Element BE, by the proxy function SP in the Border Element BE. As a result, the Call Control Element CE is advantageously protected against direct and possibly unauthorized access by the end points EP.

On the basis of information in the H.225 messages and in (e.g. central) subscriber data which it can also access, the Call Control Element CE now sets up the connection and provides the features desired by the subscriber.

The following diagram schematically shows the message flow during connection setup.

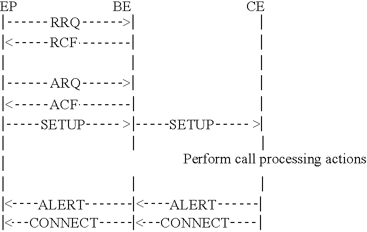

It is emphasized that the description of the components which are relevant for the invention is not intended to be restrictive in principle. It is evident to a person skilled in the relevant art that, in particular, concepts such as ‘end point’, ‘Border Element’, Access Control Element’ or ‘Call Control Element’ are understood to be functional and not physical. Said concepts can therefore be implemented partly or fully in software and/or distributed over a plurality of physical devices, for example.

1-15. (canceled).

16. A method for controlling end points of a communication network by at least one control function having at least separate Call Control and Access Control functions, wherein the functions are implemented in separate units, the method comprising:
exchanging first messages between the Access Control function and the end points, for controlling the network access of the end points; and
exchanging second messages between the Call Control function and the end points, for controlling existing network accesses of the end points.

17. The method as claimed in claim 16, wherein the second messages are switched between the Call Control function and the end points by a Signaling Proxy function.

18. The method as claimed in claim 17, wherein the Signaling Proxy function is implemented in the same unit as the Access Control function.

19. The method as claimed in claim 16, wherein the units are implemented by different devices.

20. A device, comprising at least a Call Control function but not a Access Control function.

21. The device as claimed in claim 20, comprising at least one Call Processing function.

22. A device, comprising at least a Access Control function but not a Call Control function.

23. The device as claimed in claim 22, further comprising a Signaling Proxy function for switching Call Control messages.

24. The device as claimed in claim 20, further comprising at least one individual network address.

25. The device as claimed in claim 20, wherein the device is a Call Control Element.

26. The device as claimed in claim 21, wherein the Call Processing function performs routing or billing or supplementary features or conversion to other signaling.

27. The device as claimed in claim 24, wherein the individual network address is used for differentiating from further devices.

28. The device as claimed in claim 22, wherein the device is a Border Element.

29. A computer program product having software code sections to perform a method for controlling end points of a communication network by at least one control function, which comprises at least Call Control and Access Control functions, wherein the functions are implemented in separate units, of which one comprises the Call Control function but not the Access Control function, and one comprises the Access Control function but not the Call Control function, the method comprising:
exchanging first messages between the Access Control function and the end points, for controlling the network access of the end points; and
exchanging second messages between the Call Control function and the end points, for controlling existing network accesses of the end points.

30. An arrangement for controlling end points of a communication network, comprising:
at least one device, the device having at least the Call Control function but not the Access Control function; and/or
a computer program product, the computer program product having software code sections to perform a method for controlling end points of a communication network by at least one control function, which comprises at least Call Control and Access Control functions, wherein the functions are implemented in separate units, of which one comprises the Call Control function but not the Access Control function, and one comprises the Access Control function but not the Call Control function, the method comprising:
exchanging first messages between the Access Control function and the end points, for controlling the network access of the end points; and
exchanging second messages between the Call Control function and the end points, for controlling existing network accesses of the end points.

31. The arrangement as claimed in claim 30, wherein at least one Border Element is assigned to each interface between a first communication network and a further second communication networks, compared with which at least one Call Control Element is arranged centrally in the first communication network.

32. The arrangement as claimed in claim 30, comprising more Border Elements than Call Control Elements.

33. The arrangement as claimed in claim 30, wherein the arrangement is a group of communication networks.

34. A control function, whose associated functions are divided among at least two different units, wherein a first unit is assigned at least the Access Control function and a second unit is assigned at least the Call Control function.

35. A Dividing for the functions of a control function, wherein its Call Control and Access Control functions are assumed by different units.

36. A Dividing as claimed in claim 35, wherein the dividing is a splitting and/or a distributing.
